(19) United States
(12) Patent Application Publication
(10) Pub. No.: US 2011/0114407 A1
(43) Pub. Date: May 19, 2011

(54) Bicycle-running assistant system

(76) Inventor: Chih Hsing Lee, Xizhi City (TW)

(21) Appl. No.: 12/591,276

(22) Filed: Nov. 16, 2009

(51) Int. Cl. B62M 6/75

(52) U.S. Cl. 180/205

(57) ABSTRACT

A bicycle-running assistant system includes a wheel mover detachably fastened to the seat tube of a bicycle and holding an external rotor motor in friction contact with the rear wheel of the bicycle and controllable to rotate the rear wheel of the bicycle by means of a friction force, a rechargeable battery pack mounted on the seat pillar of the saddle of the bicycle to provide the external rotor motor of the wheel mover with the necessary working voltage, and a speed controller mounted on the handlebars of the bicycle for regulating the speed of the external rotor motor.

### BACKGROUND OF THE INVENTION

1. Field of the Invention

The present invention relates to bicycles and more particularly, to a bicycle-running assistant system for installation in a bicycle to rotate the rear wheel by means of a friction force subject to the operation of a battery-operated motor rotor.

2. Description of the Related Art

Following the growing awareness of environmental protection concept and the growing of energy crisis, bicycle has been intensively used by people as one's personal transportable vehicle for the purpose of exercise. Using a bicycle as one's personal transportable vehicle instead of a motorcycle or car effectively achieves energy saving and carbon reduction. Many bicycles are made foldable so that a user can carry a folding bicycle conveniently as taking a mass transportable vehicle. There are bicycles equipped with an assistant system to assist the user reduce physical load. However these designs have drawbacks as follows:

1. The assistant system is not a DIY (do-it-yourself) design, not practical for installation in a bicycle by a user.

2. During operation of the motor of the assistant system, the pedals of the bicycles are rotated. The rotating pedals may hit the bicycle rider's legs accidentally, causing an injury.

3. During rotation of the gears and the chain, a high level of noise is produced.

Therefore, it is desirable to provide a bicycle-running assistant system that eliminates the aforesaid drawbacks.

### SUMMARY OF THE INVENTION

The present invention has been accomplished under the circumstances in view. It is one object of the present invention to provide a bicycle-running assistant system, which has light weight and small size characteristics. It is still another object of the present invention to provide a bicycle-running assistant system, which is of a DIY design practical for installation in any of a variety of bicycles by a user conveniently. It is still another object of the present invention to provide a bicycle-running assistant system, which utilizes a battery-operated external rotor motor to rotate the rear wheel of the bicycle in which the system is installed by means of a friction force, enabling the bicycle rider to ride the bicycle with less effort.

To achieve these and other objects of the present invention, a bicycle-running assistant system comprises a wheel mover mounted on the seat tube of a bicycle, a rechargeable battery pack mounted on the bicycle and adapted for providing the necessary working voltage to the wheel mover, and a speed controller for controlling the speed of the wheel mover. The wheel mover comprises a motor holder holding a motor, for example, external rotor motor that can be moved into friction contact with the rear wheel of the bicycle and then controlled to rotate the rear wheel of the bicycle, a support shaft movably coupled to the motor mount, and a clamp pivotally connected to the support shaft for fastening to the seat tube of the bicycle.

### BRIEF DESCRIPTION OF THE DRAWINGS

FIG. 1 illustrates a bicycle-running assistant system installed in a bicycle according to the present invention.

FIG. 2 is a side view of FIG. 1.

FIG. 3 is an enlarged view of a part of FIG. 1, showing the arrangement of the speed controller on the handlebars of the bicycle.

FIG. 4 is an enlarged view of another part of FIG. 1, showing the arrangement of the wheel mover on the seat tube of the bicycle.

FIG. 5 is an elevational view of the wheel mover of the bicycle-running assistant system according to the present invention.

FIG. 6 is a side view of the wheel motor shown in FIG. 5.

FIG. 7 is a top view of the wheel motor shown in FIG. 5.

FIG. 8 is an exploded view of the component parts of the wheel motor according to the present invention.

### DETAILED DESCRIPTION OF THE PREFERRED EMBODIMENT

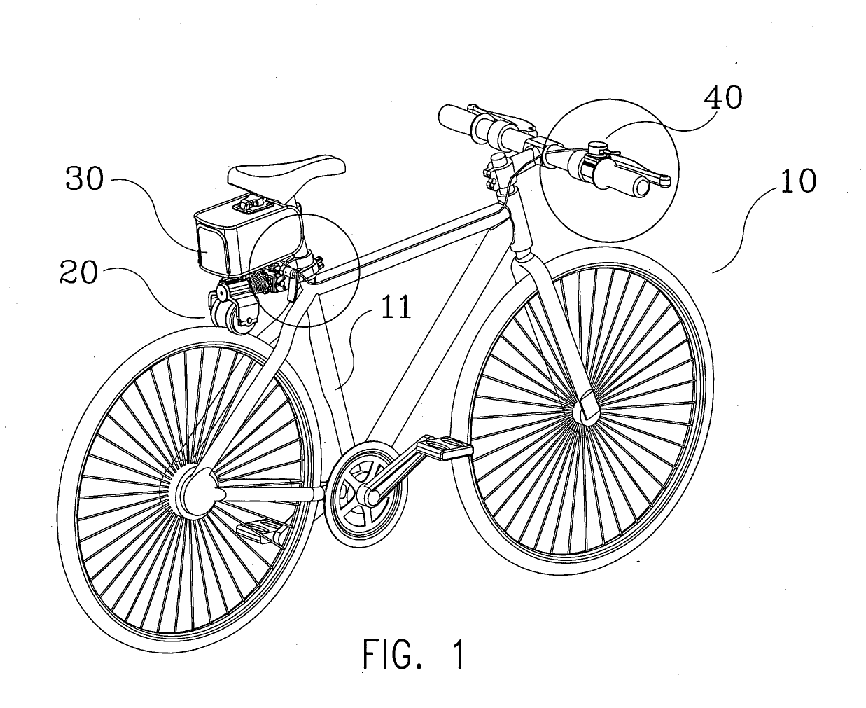

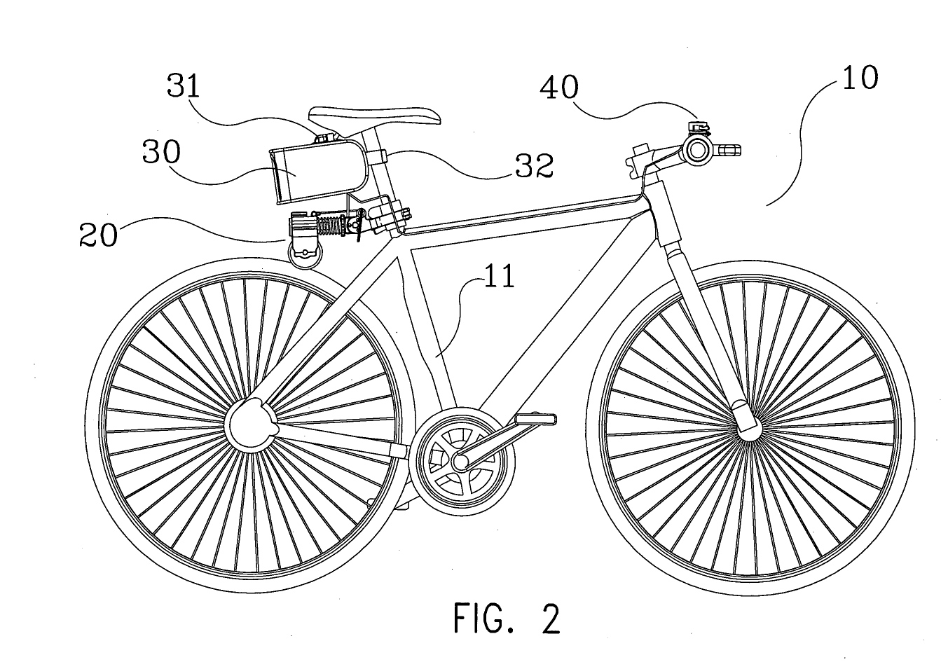

Referring to FIGS. 1 and 2, a bicycle-running assistant system in accordance with the present invention is shown comprising a wheel mover 20, a rechargeable battery pack 30 and a speed controller 40.

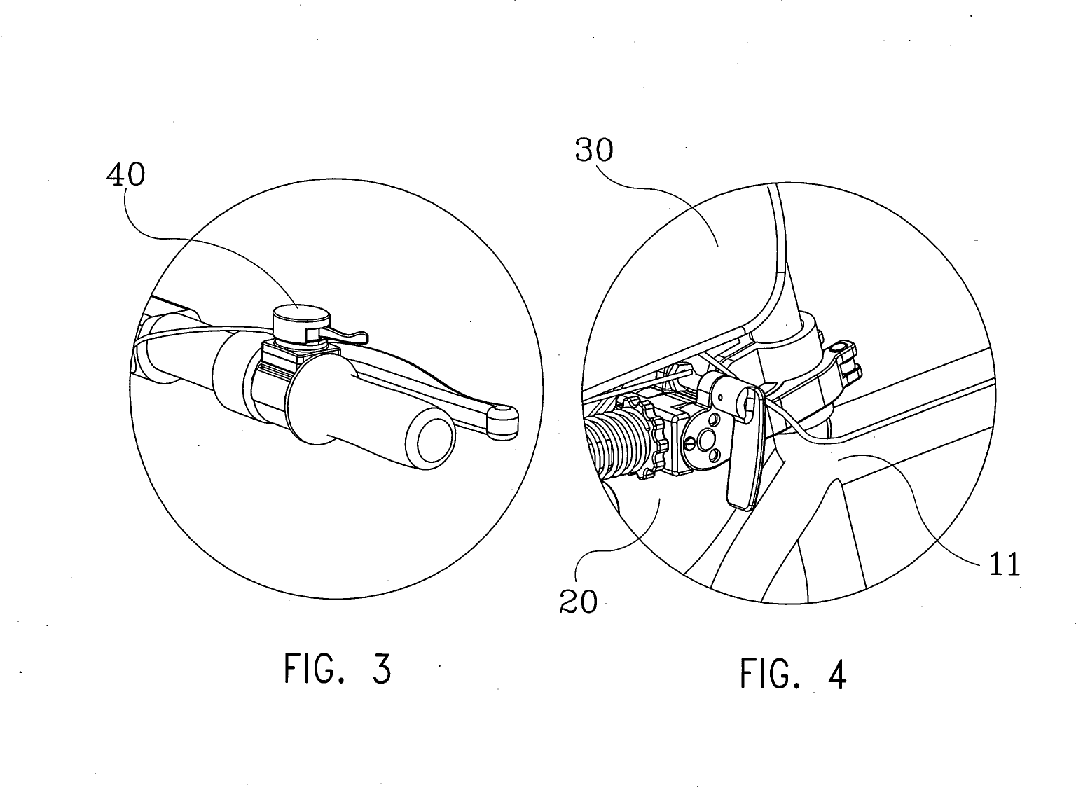

The wheel mover 20 is affixed to the seat tube 11 of a bicycle 10 (see FIG. 2 and FIG. 4). The rechargeable battery pack 30 is affixed to the seat pillar of the saddle of the bicycle 10 by means of a clamp 31 and fastening belt 32. Further, the speed controller 40 is installed in the handlebar of the bicycle 10 (see FIG. 3).

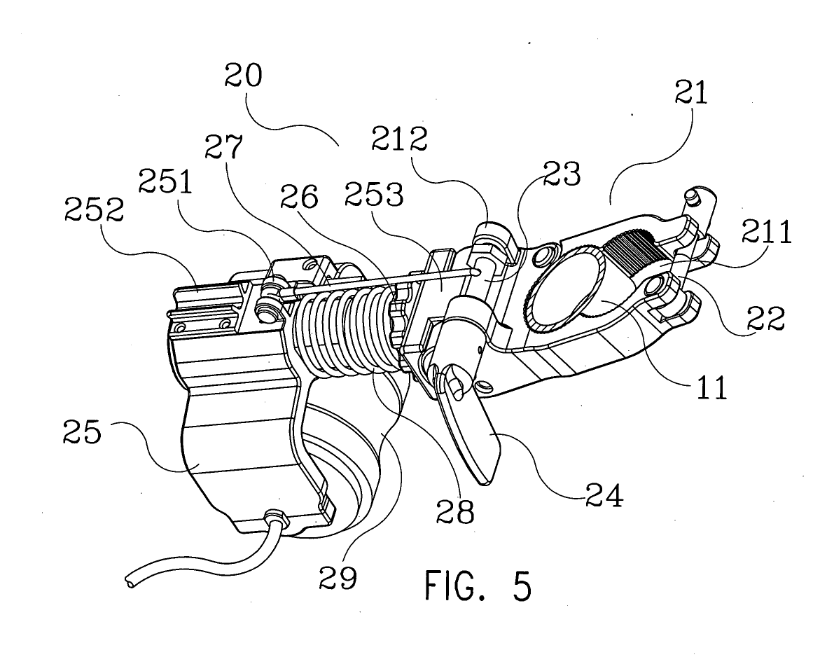

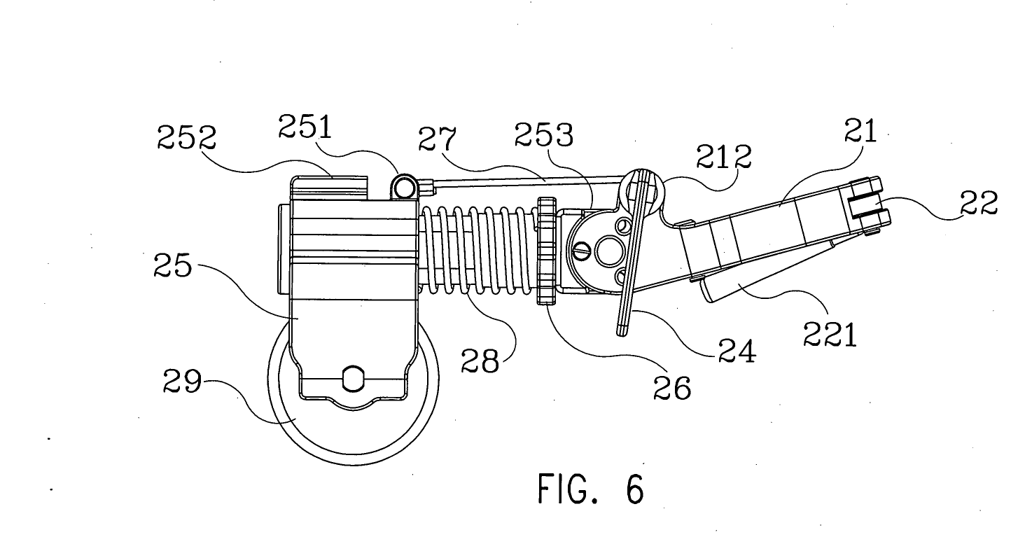

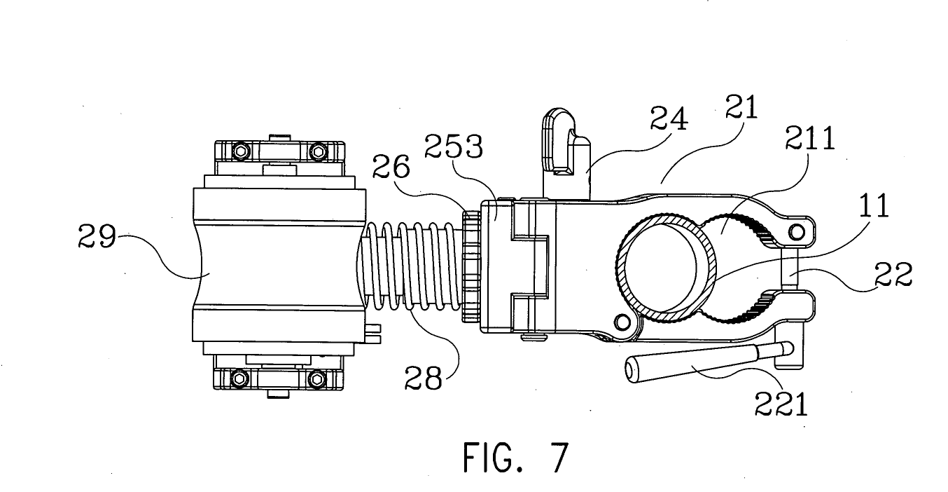

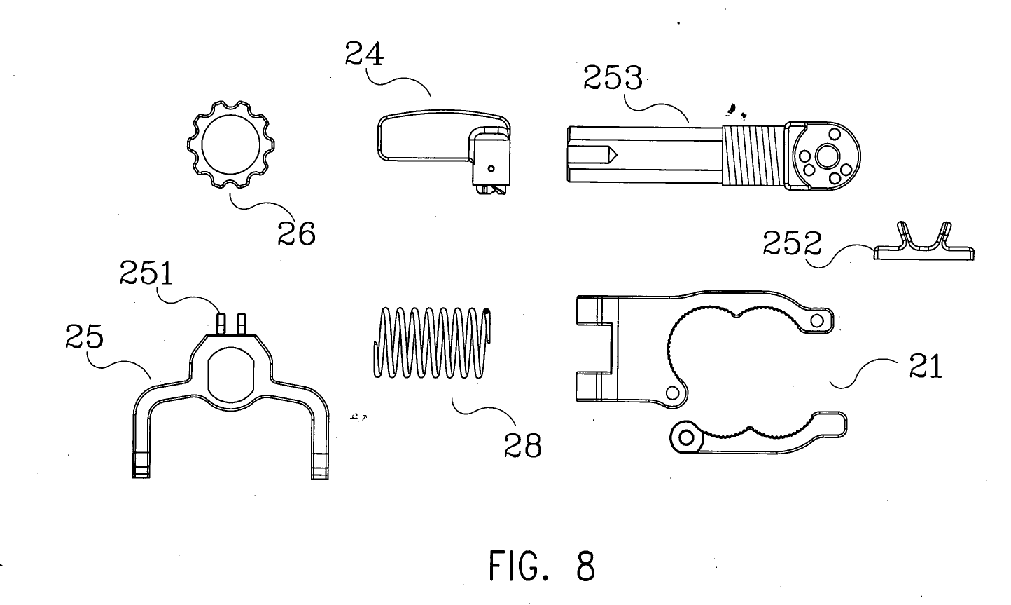

Referring to FIGS. 5˜8, the wheel mover 20 comprises a motor holder 25, a support shaft 253 movably coupled to the motor holder 25, a clamp 21 formed of a fixed jaw and a movable jaw and pivotally connected to one end of the support shaft 253 and defining a clamping mouth 211 between the fixed jaw and the movable jaw for receiving the seat tube 11 of the bicycle 10, a locking pin 22 pivotally connected to the free end of the fixed jaw of the clamp 21, an operating handle 221 pivotally connected to the free end of the locking pin 22 and operable to secure the free end of the locking pin 22 to the free end of the movable jaw of the clamp 21 and to further lock the clamp 21 to the seat tube 11 of the bicycle 10, a pivot holder 212 located on the fixed end of the fixed jaw of the clamp 21, a pivot 23 pivotally supported in the pivot holder 212, a finger bar 24 fixedly connected to one end of the pivot 23 and operable to rotate the pivot 23 relative to the pivot holder 212, a locating block 251 located on the top side of the motor holder 25, a steel wire rod 27 connected between the locating block 251 and a middle part of the pivot 23, a spring member 28 sleeved onto the support shaft 253 and stopped against the motor holder 25, an adjustment nut 26 threaded onto the support shaft 253 and stopped against one end of the spring member 28 opposite to the motor holder 25 and rotatable relative to the support shaft 253 to adjust the spring force of the spring member 28, a motor 29 mounted in the motor holder 25 at the bottom side and electrically connected to the rechargeable battery pack 30, and a fender plate 252 covered on the top side of the motor holder 25 to work as a mudguard. Further, the motor 29 according to the present preferred embodiment is an external rotor motor for rotating the real wheel of the bicycle 10 by means of a friction force.

During application of the present invention, fasten the clamp 21 of the wheel mover 20 to the seat tube 11 of the bicycle 10 (see FIG. 2), and then operate the finger bar 24 to rotate the pivot 23, enabling the support shaft 253 to be lowered relative to the clamp 21 to force the external rotor motor 29 into friction contact with the rear wheel of the bicycle 10, and then rotate the adjustment nut 26 to adjust the spring force of the spring member 28, tightening friction contact between the external rotor motor 29 and the rear wheel of the bicycle 10. Thereafter, affix the rechargeable battery pack 30 to the seat pillar of the saddle of the bicycle 10 by means of the clamp 31 and the fastening belt 32 and electrically connected to the rechargeable battery pack 30 to the external rotor motor 29, and then affix the speed controller 40 to the handlebar of the bicycle 10 and electrically connect the speed controller 40 to the external rotor motor 29 and the rechargeable battery pack 30 (see FIG. 3). The rechargeable battery pack 30 provides 250 W battery power so that the external rotor motor 29 is cable of rotating the real wheel of the bicycle 10 at a speed about 15 kms per hour continuously for a distance about 13 kms.

When not in use, operate the finger bar 24 to rotate the pivot 23 in the reversed direction, releasing the external rotor motor 29 from the rear wheel of the bicycle 10. At this time, the bicycle rider can pedal the pedals of the bicycle 10 to move the bicycle 10 forwards without assistance of the bicycle-running assistant system.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bicycle-running assistant system installed in a bicycle to assist running, the bicycle-running assistant system comprising:
a wheel mover, said wheel mover comprising a motor holder, a motor mounted in said motor holder and movable with said motor holder into friction contact with a rear wheel of said bicycle and rotatable to move said rear wheel of said bicycle by means of a friction force, a support shaft movably coupled to said motor holder, an adjustment nut threaded onto said support shaft, a spring member sleeved onto said support shaft and stopped between said motor holder and said adjustment nut, a locating block located on a top side of said motor holder, a clamp formed of a fixed jaw and a movable jaw and pivotally connected to one end of said support shaft remote from said motor holder, a locking pin pivotally connected to the free end of the fixed jaw of said clamp, an operating handle pivotally connected to the free end of said locking pin and operable to secure the free end of said locking pin to the free end of said movable jaw of said clamp and to further lock said clamp to a seat tube of said bicycle, a pivot holder located on the fixed jaw of said clamp adjacent to said support shaft, a pivot pivotally supported in said pivot holder, a finger bar fixedly connected to one end of said pivot and operable to rotate said pivot relative to said pivot holder, a steel wire rod connected between said locating block and said pivot, a spring member sleeved onto said support shaft and stopped against said motor holder, an adjustment nut threaded onto said support shaft and stopped against one end of said spring member opposite to said motor holder and rotatable relative to said support shaft to adjust the spring force of said spring member, and a fender plate covered on a top side of said motor holder to work as a mudguard;
a rechargeable battery pack installed in said bicycle and adapted for providing said motor with the necessary working voltage; and
a speed controller installed in said bicycle and adapted for controlling the speed of said motor.
